(19) United States
(12) Patent Application Publication
(10) Pub. No.: US 2010/0250828 A1
(43) Pub. Date: Sep. 30, 2010

(54) CONTROL SIGNAL OUTPUT PIN TO INDICATE MEMORY INTERFACE CONTROL FLOW

(76) Inventor: Brent Ahlquist, Loomis, CA (US)

Correspondence Address: SCHWABE, WILLIAMSON & WYATT, P.C., PACWEST CENTER, SUITE 1900, 1211 SW FIFTH AVENUE, PORTLAND, OR, 97204, US

(21) Appl. No.: 12/412,829

(22) Filed: Mar. 27, 2009

(51) Int. Cl. G06F 12/02; G06F 12/00

(52) U.S. Cl. 711/103; 711/154; 711/104; 711/E12.001; 711/E12.008

(57) ABSTRACT

Embodiments include but are not limited to apparatuses and systems including a memory array including a plurality of non-volatile memory cells, and a control signal output pin operatively coupled to the memory array. The control signal output pin may be configured to provide a control signal indicative of the memory interface control flow including, for example, an availability of the memory array for reading or writing. Other embodiments may be described and claimed.

### TECHNICAL FIELD

Embodiments of the present disclosure relate generally to memory devices, and more particularly, to a control signal output pin configured to provide a control signal indicative of memory interface control flow.

### BACKGROUND

The demand for increasingly faster devices has posed a number of challenges. One area in particular includes those memory apparatuses including both non-volatile memory as well as random access memory (RAM) sharing a common interface. Because these different types of memory may have different latencies, software polling and other throttling mechanisms may need to be employed to manage reads and writes.

### BRIEF DESCRIPTION OF THE DRAWINGS

Embodiments of the present disclosure will be readily understood by the following detailed description in conjunction with the accompanying drawings. To facilitate this description, like reference numerals designate like structural elements. Embodiments of the disclosure are illustrated by way of example and not by way of limitation in the figures of the accompanying drawings.

FIG. 1 illustrates a memory apparatus including a control signal output pin in accordance with various embodiments.

FIG. 2 illustrates another memory apparatus including a control signal output pin in accordance with various embodiments.

FIG. 3 is a flowchart illustrating operation of a memory apparatus including a control signal output pin in accordance with various embodiments.

FIGS. 4-7 are example timing diagrams for memory apparatuses including a control signal output pin in accordance with various embodiments.

FIG. 8 is a flowchart illustrating operation of a memory apparatus including a control signal output pin in accordance with various embodiments.

FIG. 9 is a block diagram of an example system incorporating a memory apparatus having a control signal output pin in accordance with various embodiments

### DETAILED DESCRIPTION

In the following detailed description, reference is made to the accompanying drawings which form a part hereof wherein like numerals designate like parts throughout, and in which is shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

Various operations may be described as multiple discrete operations in turn, in a manner that may be helpful in understanding embodiments of the present disclosure; however, the order of description should not be construed to imply that these operations are order dependent. Moreover, some embodiments may include more or fewer operations than may be described.

The description may use the phrases “in an embodiment,” “in embodiments,” “in some embodiments,” or “in various embodiments,” which may each refer to one or more of the same or different embodiments. Furthermore, the terms “comprising,” “including,” “having,” and the like, as used with respect to embodiments of the present disclosure, are synonymous.

As used herein, “coupled,” along with its derivatives, may mean one or more of the following. “Coupled” may mean a direct physical or electrical coupling or connection, wherein there is no other element coupled or connected between the elements that are said to be coupled with each other. “Coupled” may also mean an indirect physical or electrical coupling or connection, where one or more other elements are coupled or connected between the elements that are said to be coupled with each other.

For the purposes of the present disclosure, the phrase “A/B” means A or B. The phrase “A and/or B” means “(A), (B), or (A and B).” The phrase “at least one of A, B, and C” means “(A), (B), (C), (A and B), (A and C), (B and C), or (A, B and C).” The phrase “(A)B” means “(B) or (AB),” that is, A is an optional element. In addition, although embodiments of the present disclosure may be shown and described as including a particular number of components or elements, embodiments of the disclosure are not limited to any particular number of components or elements.

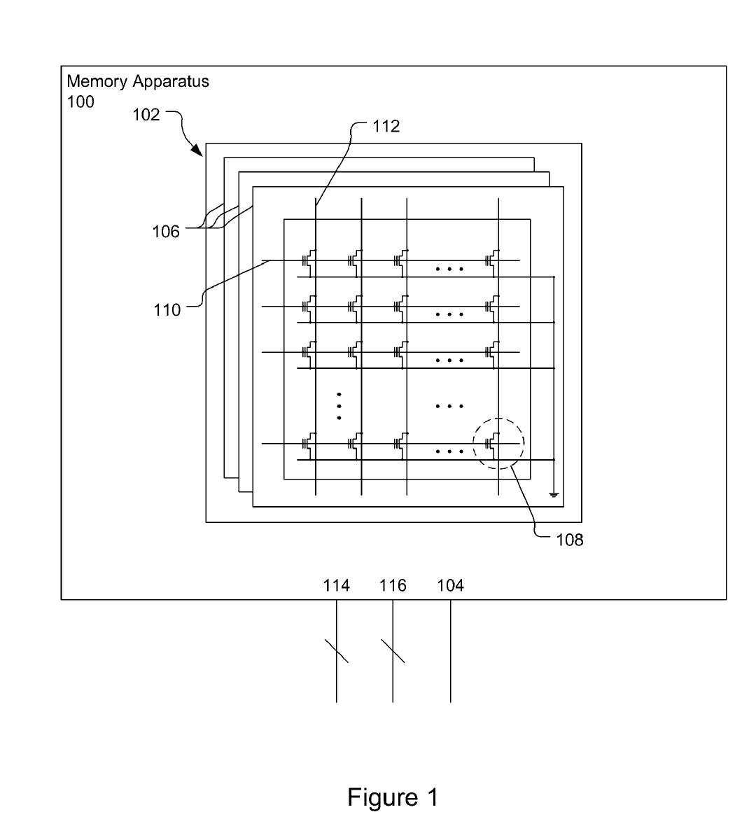

Turning now to FIG. 1, illustrated is a memory apparatus 100 in accordance with various embodiments of the disclosure. In various embodiments, the memory apparatus 100 may comprise a memory array 102 including a plurality of addressable memory banks 106. Each memory bank 106 may include a similarly-constituted plurality of memory cells 108 (e.g., a plurality of flash memory cells) coupled to word-lines 110 (rows) and bit-lines 112 (columns). Each memory bank 106 may contain addressable blocks (or sectors) of memory cells 108.

The memory array 102 may include any suitable memory cells. In various other embodiments, the memory array 102 may include an array of memory cells that are each formed by a floating gate metal oxide semiconductor (MOS) transistor or other transistor or transistor-like technologies. In various embodiments, the memory array may include any suitable non-volatile memory such as, but not limited to, NOR flash memory, NAND flash memory, phase change memory, etc.

Data may be stored in the memory apparatus 100 and accessed by way of commands provided to the memory apparatus 100. To that end, the memory apparatus 100 may include a plurality of address 114 and data 116 pins operatively coupled to the plurality of memory cells 108. The memory apparatus 100 may include decoding and driving circuitry (not illustrated) for accessing the memory cell contents. Data may be input and output by way of suitable write and read circuitry including, for example, sense amplifiers for read operations as well as analog circuitry for controlling programming and erase voltage generators and controlling the duration of voltage pulses to the memory array 102.

The memory apparatus 100 may include a control signal output pin 104 operatively coupled to the plurality of memory cells 108. The control signal output pin 104 may be configured to provide a control signal indicative of control flow of the memory interface. For example, the control signal output pin 104 may be configured to provide a control signal indicative of any one or more of an availability of the memory array 102 for reading or writing, or a write condition, a read condition, a programming or internal controller condition, or a memory cell condition needing attention.

Implementing the control signal output pin 104 as described herein may allow for avoiding, or reducing, the use of traditional software polling to manage operations on the memory apparatus 100. Although these polling software are sometimes used for a variety of types of memory apparatuses, non-volatile memory devices often use software polling or other general throttling mechanisms. This may be especially true when such non-volatile memory apparatuses (e.g, NOR devices, PCM devices, etc.) share a bus with random access memory (RAM) due at least in part to the read and write latency differences between the non-volatile memory and the RAM (i.e., the latencies of the non-volatile memory are typically longer than the RAM latencies).

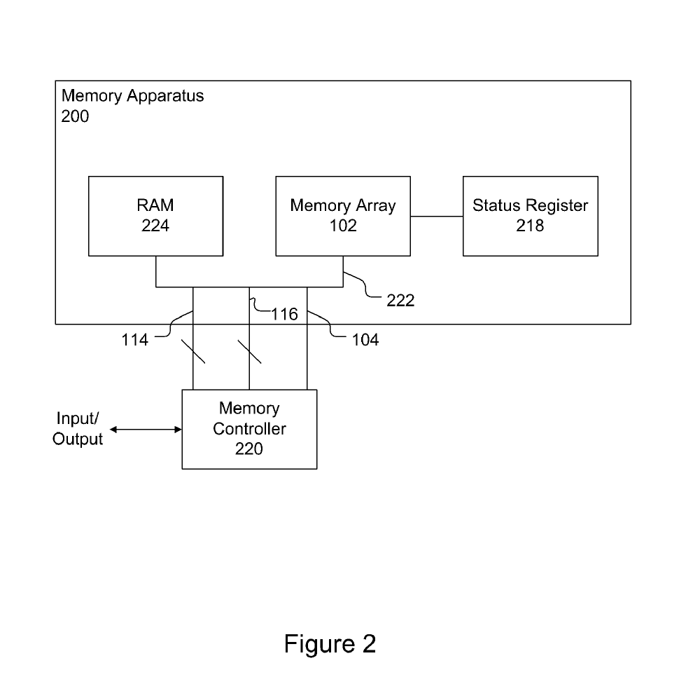

In various embodiments, the meaning of the control signal (e.g., the condition needing attention) may be determined based at least in part on the context in which the control signal is asserted. More specifically, the meaning of the control signal may be determined based at least in part on whether the control signal is asserted during or following a read operation or a write operation. To facilitate determination of the meaning of a control signal, a memory apparatus 200 may include a memory controller 220 operatively coupled to the memory array 102 as illustrated in FIG. 2. In various embodiments, the memory controller 220 may also be operatively coupled to random access memory (RAM) 224 of the memory apparatus 100 over a shared bus 222. The memory apparatus 200 may also include a control signal output pin 104, and a plurality of address 114 and data 116 pins.

The memory controller 220 may be configured to analyze the control signal when asserted or to take action if an expected control signal is not issued. To that end, the memory controller 220 may be configured to start a WatchDog timer when a read command or a write command is issued to the memory array 102. If the control signal output pin 104 fails to provide the control signal on time-out of the WatchDog timer, the memory controller 220 may be configured to issue an interrupt for a host device hosting the apparatus. In these embodiments, the assumption may be that throttling outside of a tolerable or expected time period due to a command error is rare and so permitting an interrupt in these situations would not lead to undesirably frequent interruption.

In various embodiments, the meaning of the control signal may depend on the time period during which the control signal is asserted or de-asserted. In other words, the meaning of the control signal may be context-specific. In various embodiments, for example, the contexts may be generally categorized as (1) after a read and (2) outside of a read (i.e., periods other than those during reads).

Outside of a read, an asserted control signal may indicate the availability of a quantity of minimum burst size write resources, while a de-asserted control signal may mean the unavailability of a quantity of minimum burst size write resources or a need for attention due to the internal execution engine logging an error or completing a command. The control signal may be asserted, for example, to indicate space is available in a write buffer of the memory array 102 for writing. In embodiments, the control signal may be asserted to indicate that one or more entries, or some minimum size write burst, are available (or is below some configurable high watermark) on the memory array 102 for immediate writing or commitment to write, while subsequent write transactions may then be queued up for subsequent write transactions. The control signal may then be de-asserted for data writing, and then asserted when available again for writing.

If, on the other hand, the asserted control signal indicates a need for attention due to the internal execution engine logging an error, an interrupt will eventually be issued by the controller 220 on the next write after the WatchDog timer expires. The interrupt handler can then read a status register 218 to determine the cause of the condition needing attention. The status register 218 may be configured to store control information associated with any one or more of the write condition, the read condition, the programming condition, and the memory cell condition needing attention. Accordingly, when the control signal is asserted, the status register 218 may be accessed to determine, or to help determine, the meaning of the control signal.

In various embodiments, the apparatus 200 may be configured to provide the control signal to indicate a completion of a command (e.g., a read or write command). In various other embodiments, however, the apparatus 200 may be configured to not provide such a signal on command completion.

After a read, the control signal may be indicative of an arrival of read data requested. In embodiments, the control signal may be de-asserted on receipt of a read command requesting data, and then asserted when the requested data is available for reading.

In various embodiments, if the control signal is asserted during a write operation in which data is written to the memory apparatus 200, this may implicitly indicate that there was a failure of the write operation (e.g., did not complete within a specified amount of time) and that the write operation may need to be re-tried. In various embodiments, the write operation may be re-tried at the time the control signal is asserted, may instead be scheduled to occur at a later time, or may be cancelled (i.e., not re-performed at all). In other words, the occurrence or timing of the occurrence of the retry is not necessarily dictated by the occurrence of the assertion.

If the control signal is asserted during a read operation, this may be indicative of any one or more of a read condition, a programming condition, or a memory cell condition needing attention. The control signal may implicitly indicate, for instance, that the current read operation failed (e.g., returned invalid or incomplete data, or did not complete within a specified amount of time) and that the read operation may need to be re-tried, In some embodiments, the control signal may implicitly indicate another problem or error that may need to be investigated.

In various embodiments, the control signal may be indicative of a programming condition such as, for example, a programming error, or a memory cell condition such as, for example, a memory array error. The conditions may be software or hardware in nature.

If it is determined that the control signal indicates a read or write failure, the read or write operation may be re-tried at the time the control signal is asserted or may instead be scheduled to occur at a later time (e.g., the retry may be prioritized or scheduled when the memory array 102 is again accessible for a read).

In various embodiments, the controller 220 may terminate a read transaction via a Burst Terminate (BST) command. In one usage, the BST issued immediately after the CAS read cycle may indicate the desire to continue the transaction in the background with the assumption that the command will be re-issued in the future (pre-fetch). This may require the appropriate buffering facilities in the memory apparatus 200 to store the pre-fetched data. In another usage, a delayed BST may simply cancel or abort the current CAS read command. This may occur when a controller WatchDog timer expires and may simultaneously result in a forced host interrupt. Thus, BST command generation may be a host memory controller reaction to particular policies and/or event rather than directly software controlled.

In various embodiments, the memory controller 220 may be configured to cause re-performance of one or more operations that were being performed at the time of the assertion of the control signal. For example, the memory controller 220 may be configured to cause re-performance of a write operation or a read operation if the control signal indicates failure of the write operation or read operation, respectively. The memory controller 220 may be configured to cause the re-performance either before or after facilitating performance of one or more other operations on the memory array 102. As alluded to herein, the memory controller 220 may be configured to interpret the control signal in combination with the context-specific WatchDog timer expiration, sometimes along with a read of the status register 218.

For embodiments in which the memory controller 220 manages the re-tries, the memory apparatus 220 or device hosting the memory apparatus 220 may include a counter to indicate a maximum retry count.

Although not illustrated, multiple memory apparatuses 200 may be coupled in parallel. In these embodiments, the control signal output pin 104 may be configured with an open drain to allow for interleaving.

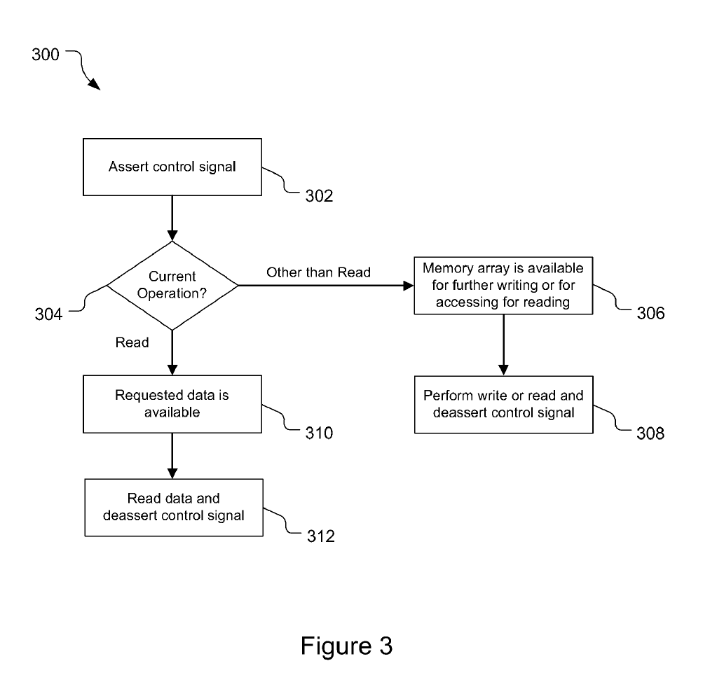

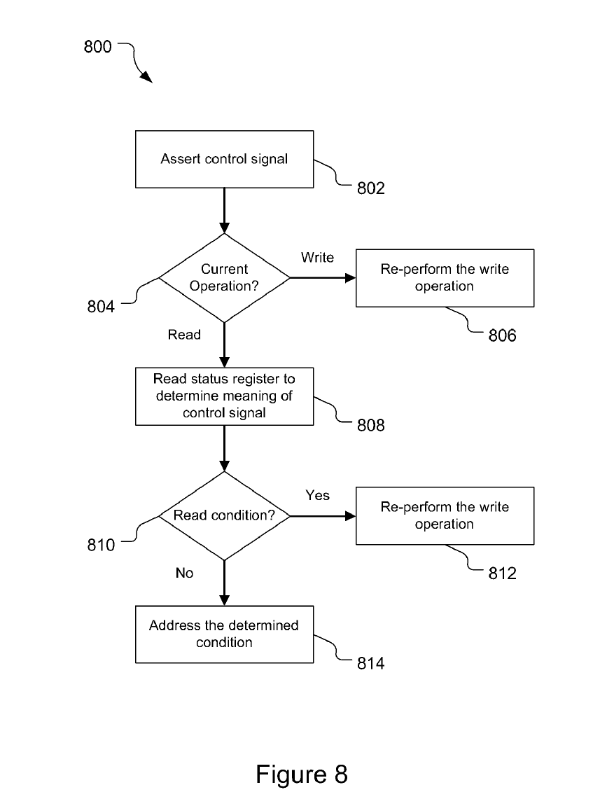

To clarify the operation of the foregoing memory apparatuses, FIG. 3 and FIG. 8 illustrate flowcharts depicting operations of memory apparatuses described herein. FIG. 3 illustrates a flowchart 300 depicting operation of memory apparatuses including a control signal output pin operatively coupled to the plurality of memory cells and configured to provide a control signal indicative of an availability of a memory array for reading or writing. FIG. 8 illustrates a flowchart 400 depicting operation of memory apparatuses including a control signal output pin operatively coupled to the plurality of memory cells and configured to provide a control signal indicative of a write condition, a read condition, a programming condition, or a memory cell condition needing attention.

At block 302 of FIG. 3, the control signal may be asserted, and then at block 304, the current operation may be determined. The current operation may be, for example, a read operation or another operation (e.g., other than a read operation).

In various embodiments, if the current operation is a write operation, the assertion of the control signal may indicate that the memory array is available for further writing or for accessing for reading (block 306). The further writing or accessing of the memory array for reading may then be performed and the control signal de-asserted (block 308).

If, however, the current operation is a read operation, the assertion of the control signal may indicate that the requested data is ready for reading (block 310). The requested data may then be read and the control signal de-asserted (block 312).

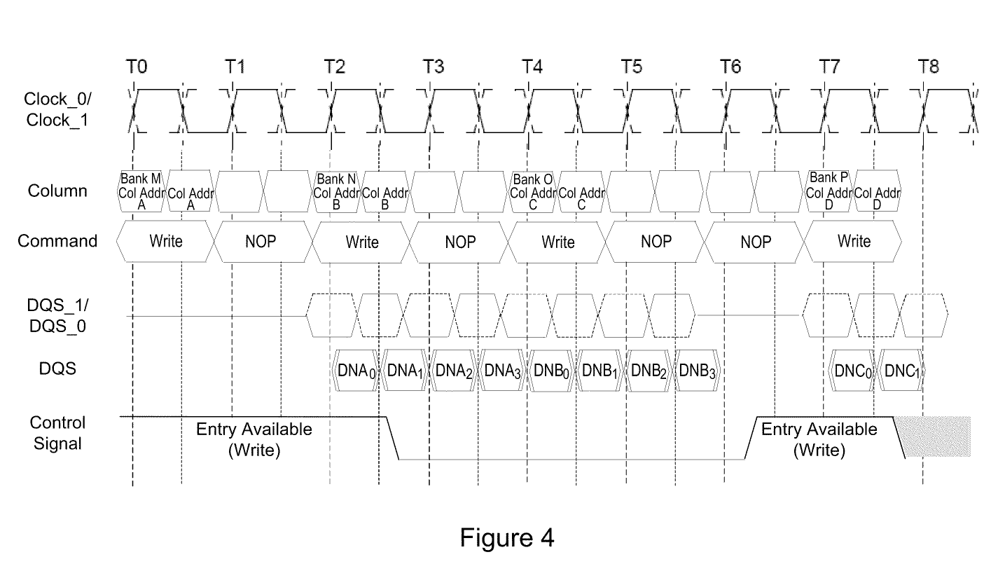

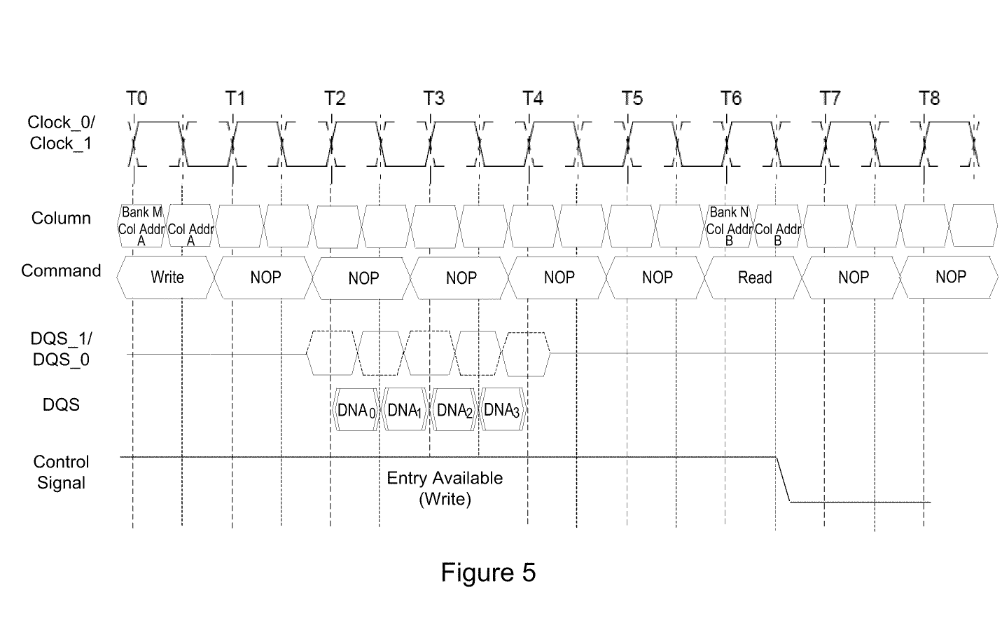

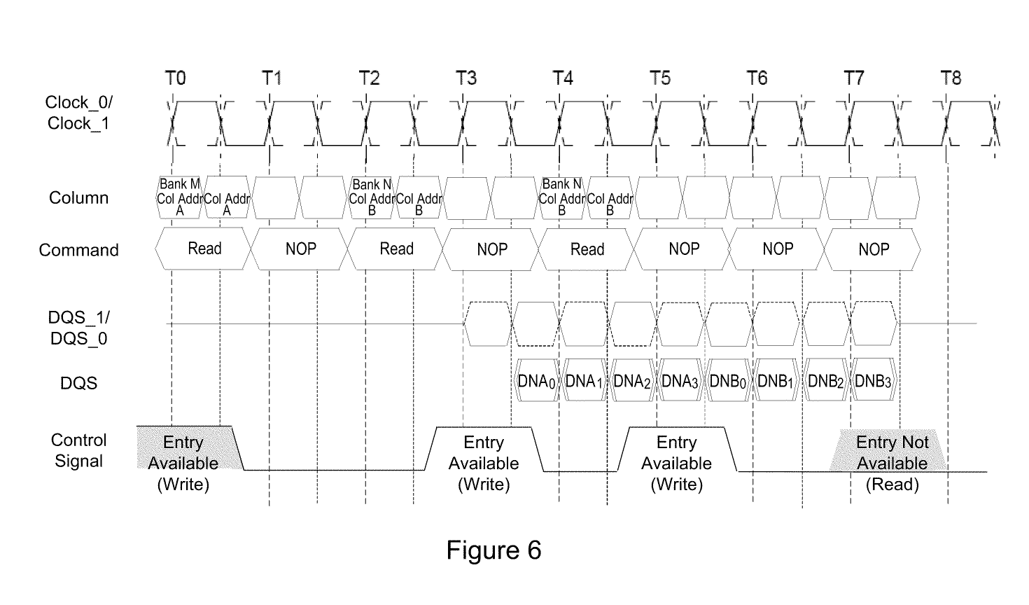

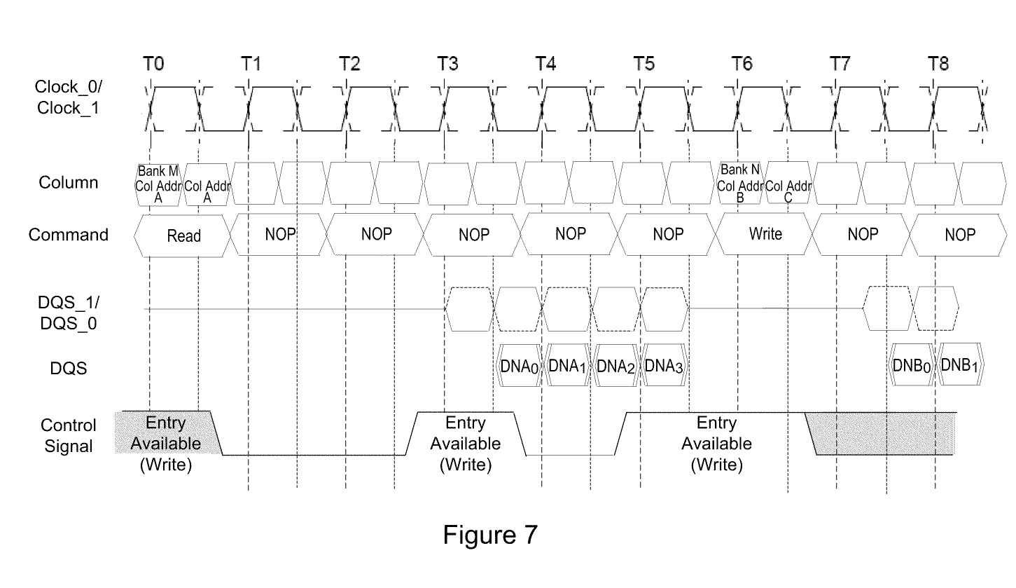

To help clarify the timing of the control signal in relation to read and write operations, FIGS. 4-7 provide example timing diagrams for illustrating the use of a control signal for indicating a condition of a memory array. FIG. 4 illustrates a write to write transition, while FIG. 5 illustrates a write to read transition. FIG. 6 illustrates a read to read transition, while FIG. 7 illustrates a read to write transition. In general, the timing diagrams depict that the control signal generally indicates space availability in the memory array for writing or the availability of the requested read data, depending at least in part on the previous command or action.

Turning now to FIG. 8, illustrated is a method 800 which may be practiced with methods described herein. For example, the illustrated method may be practiced with the method illustrated in FIG. 3.

At block 802, the control signal may be asserted, and then at block 804, the current operation may be determined. The current operation may be, for example, a read operation or a write operation.

In various embodiments, if the current operation is a write operation, the write operation may be re-performed (block 806). If however, the current operation is a read operation, the status register may be accessed to determine the meaning of the control signal (block 808).

If it is determined the current operation is a read condition (e.g., a read failure) (block 810), the read operation may be re-performed (block 812). If, however, it is determined that some other condition has occurred, then the determined condition may be addressed as appropriate (block 814).

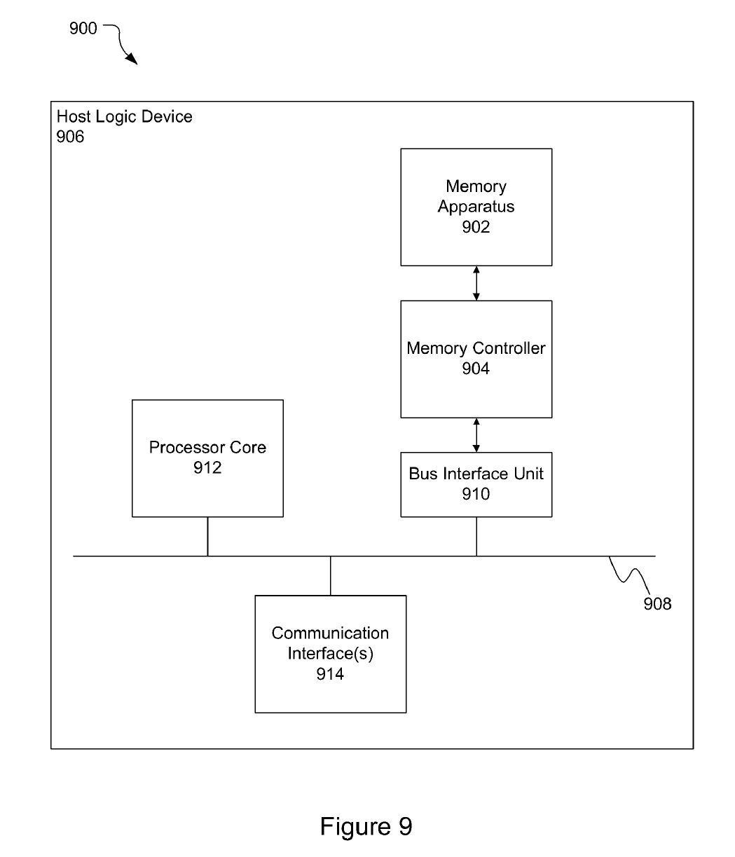

Embodiments of memory apparatuses described herein may be incorporated into various systems, including but are not limited to various computing and/or consumer electronic devices/appliances, such as desktop or laptop computers, servers, set-top boxes, digital reorders, game consoles, personal digital assistants, mobile phones, digital media players, and digital cameras. A block diagram of an example system 900 is illustrated in FIG. 9.

As illustrated, the system 900 may include a memory apparatus 902. The memory apparatus 902 may include a control signal output pin operatively coupled to the plurality of memory cells and configured to provide a control signal indicative of an availability of the memory apparatus for reading or writing, or a write condition, a read condition, a programming condition, or a memory cell condition needing attention. The system 900 may also include a memory controller 904 (such as, for example, memory controller 220 described herein with reference to FIG. 2).

In various embodiments, the memory apparatus 902 may be embedded in a host logic device 906. The host logic device 906 may be any device type for which flash memory may be embedded. For example, in various embodiments, the host logic device 906 may be a microcontroller or a digital signal processor. Other device types may be similarly suitable. The host logic device 406 may include a processor core 912.

The system 900 may comprise a host logic device bus 908, and a bus interface unit 910 operatively coupling the memory device 902 and the host logic device bus 906.

The system 900 may include communications interface(s) 914 to provide an interface for system 900 to communicate over one or more networks and/or with any other suitable device. Communications interface(s) 914 may include any suitable hardware and/or firmware. Communications interface(s) 914 for one embodiment may include, for example, a network adapter, a wireless network adapter, a telephone modem, and/or a wireless modem. For wireless communications, communications interface(s) 914 for one embodiment may use one or more antennas (not illustrated).

Although the present disclosure has been described in terms of the above-illustrated embodiments, it will be appreciated by those of ordinary skill in the art that a wide variety of alternate and/or equivalent implementations calculated to achieve the same purposes may be substituted for the embodiments shown and described without departing from the scope of the present disclosure. Similarly, memory devices of the present disclosure may be employed in host devices having other architectures. Those with skill in the art will readily appreciate that embodiments in accordance with the present disclosure may be implemented in a very wide variety of embodiments. This description is intended to be regarded as illustrative instead of restrictive.

What is claimed is:

1. An apparatus comprising:
a memory array including a plurality of non-volatile memory cells; and
a control signal output pin operatively coupled to the memory array and configured to provide a control signal indicative of an availability of the memory array for reading or writing.

2. The apparatus of claim 1, wherein the control signal output pin is configured to provide a control signal indicative of an availability of data for reading from the memory array.

3. The apparatus of claim 1, wherein the control signal output pin is configured to provide a control signal indicative of an availability of one or more of the memory cells for writing to the memory array.

4. The apparatus of claim 1, wherein the apparatus further comprises a memory controller operatively coupled to the memory array and configured to start a WatchDog timer when a read command or a write command is issued to the memory array.

5. The apparatus of claim 4, wherein the memory controller is further configured to issue an interrupt for a host device hosting the apparatus if the control signal output pin fails to provide the control signal on time-out of the WatchDog timer.

6. The apparatus of claim 4, further comprising a shared bus and random access memory (RAM), and wherein the memory array and the RAM are operatively coupled to the memory controller over the shared bus.

7. The apparatus of claim 1, wherein the memory cells comprise memory cells selected from the group consisting of NOR flash memory cells, NAND flash memory cells, and phase change memory cells.

8. The apparatus of claim 1, wherein the control signal output pin is configured to provide a control signal indicative of a write condition, a read condition, a programming condition, or a memory cell condition needing attention.

9. The apparatus of claim 8, wherein the apparatus further comprises a status register to store control information associated with the write condition, the read condition, the programming condition, or the memory cell condition needing attention.

10. The apparatus of claim 8, wherein the apparatus further comprises a memory controller operatively coupled to the memory array and configured to analyze the control signal when asserted.

11. The apparatus of claim 10, wherein the memory controller is further configured to cause re-performance of a write operation if the control signal indicates failure of the write operation.

12. A system comprising:
a memory apparatus including:
a plurality of non-volatile memory cells; and
a control signal output pin operatively coupled to the plurality of memory cells and configured to provide a control signal indicative of a control signal output pin operatively coupled to the memory array and configured to provide a control signal indicative of an availability of the memory array for reading or writing;
a memory controller operatively coupled to the memory apparatus and configured to determine whether the control signal indicates the availability of the memory array for reading or the availability of the memory array for writing based at least in part on an operation being performed by the memory apparatus;
a host logic device bus operatively coupled between the memory apparatus and the memory controller; and
a bus interface unit operatively coupled between the memory apparatus and the host logic device bus.

13. The system of claim 12, wherein the memory cells comprise memory cells selected from the group consisting of NOR flash memory cells, NAND flash memory cells, and phase change memory cells.

14. The system of claim 12, wherein the memory apparatus and the bus interface unit form an embedded memory module.

15. The system of claim 12, wherein the system is a selected one of a desktop or laptop computer, a servers, a set-top box, a digital reorder, a game consoles, a personal digital assistant, a mobile phone, a digital media player, or a digital camera.

16. A method comprising:
providing a memory apparatus including a memory array having a plurality of non-volatile memory cells; and
asserting a control signal to indicate an availability of the memory array for reading or writing.

17. The method of claim 16, further comprising determining whether the control signal was asserted during a write operation or a read operation.

18. The method of claim 16, further comprising starting a WatchDog timer when a read command or a write command is issued to the memory array.

19. The method of claim 18, further comprising issuing an interrupt if the control signal output pin fails to provide the control signal on time-out of the WatchDog timer.

20. The method of claim 16, wherein the control signal is further indicative of a write condition, a read condition, a programming condition, or a memory cell condition needing attention, and wherein the method further comprises reading a status register to determine whether the control information associated with the write condition, the read condition, the programming condition, or the memory cell condition needing attention.
